(19) United States
(12) Patent Application Publication
(10) Pub. No.: US 2006/0036615 A1
(43) Pub. Date: Feb. 16, 2006

(54) Method, system, and computer program product for navigating and displaying very large trees

(75) Inventors: Eric L. Masselle, Raleigh, NC (US); Patrick G. McGowan, Stoncy Creek, NC (US); Christopher J. Paul, Durham, NC (US)

Correspondence Address: HOFFMAN, WARNICK & D'ALESSANDRO LLC, 75 STATE ST, 14TH, ALBANY, NY, 12207, US

(73) Assignee: International Business Machines Corporation, Armonk, NY (US)

(21) Appl. No.: 10/917,089

(22) Filed: Aug. 12, 2004

(51) Int. Cl. G06F 7/00

(52) U.S. Cl. 707/100

(57) ABSTRACT

A method, system, and computer program product for displaying and navigating a tree. The method comprises: selecting a node on a level of the tree, wherein the node has a number of child nodes on a next level of the tree; determining if the number of child nodes of the selected node exceeds a predetermined level maximum number of child nodes; and, if the number of child nodes of the selected node exceeds the predetermined level maximum number of child nodes, displaying a single subset of the child nodes and at least one selectable affordance for displaying another subset of the child nodes.

### BACKGROUND OF THE INVENTION

1. Field of the Invention

The present invention relates generally to the display of data. More specifically, the present invention provides a method, system, and computer program product for navigating and displaying very large trees representing hierarchically-structured data.

2. Background Art

Hierarchically-structured data is frequently represented in visual displays as a tree. There are many formats for trees, but they all suffer from a major shortcoming: at any level in the tree, for very large data sets, the amount of data to be transmitted can degrade performance, and the visual display can require extensive scrolling.

When the amount of data displayed in a tree gets very large, it frequently becomes necessary to introduce some type of mechanism to manage the area consumed by the tree. This mechanism may be as simple as collapsing and expanding nodes. However, when a user expands any node in a graphical display of a tree, they may be presented with very large numbers of child nodes at the next level in the hierarchy. If this set of child nodes is overly large, its transmission can degrade performance and present an unmanageable display that overwhelms the user. A simple example of this problem is illustrated in FIGS. 1 and 2. FIG. 1 illustrates a tree 10 having eight nodes (NODE 1, NODE 2, . . . , NODE 8) at a first level 12. Assuming that NODE 1 has twenty-six child nodes NODE A, NODE B, . . . NODE Z in a second level 14 of the tree 10, and that NODE 1 has been selected by a user, the tree 10 expands as shown in FIG. 2 to include all twenty-six child nodes of NODE 1. From FIG. 2, one can easily see how unwieldy the tree 10 has become just with the display of the twenty-six child nodes of NODE 1. Now imagine how difficult it would be to display and navigate through the tree 10 if NODE 1 (and NODES 2-8) had hundreds or even thousands of child nodes in the second level 14 of the tree 10.

In view of the foregoing, there exists a need for a method, system, and computer program product for navigating and displaying very large trees representing hierarchically-structured data. Further, there exists a need for graphical user interface controls that retain the benefits of a tree model, yet minimize these and other shortcoming of the prior art.

### SUMMARY OF THE INVENTION

In general, the present invention provides a method, system, and computer program product for navigating and displaying very large trees representing hierarchically-structured data. In particular, in accordance with the present invention, the child nodes of a node in a tree are displayed in a normal fashion, except where the number of child nodes exceeds a predetermined level maximum number. In this case, a first subset of child nodes containing the level maximum number of child nodes is displayed, and a pair of affordances is added. Clicking one of these affordances causes the display to refresh, displaying the next subset of child nodes, where the next subset of child nodes also contains the level maximum number of child nodes. Clicking the other of these affordances causes the display to refresh, displaying the last subset of child nodes, where the last subset of child nodes contains, at most, the level maximum number of child nodes. Once past the initial subset of child nodes, an additional pair of affordances can be added prior to a displayed subset of child nodes, which allow the user to return to previous subsets of child nodes (e.g., the first subset of child nodes, the preceding subset of child nodes, etc.). The basic solution presented herein can be extended or modified to change the navigation behavior. For instance, the number of affordances could be reduced to allow only next-subset or previous subset navigation, or they could be extended to allow selection of a particular subset of child nodes, by listing the subsets as actively selectable elements.

A first aspect of the present invention provides a method for displaying and navigating a tree, comprising: selecting a node on a level of the tree, wherein the node has a number of child nodes on a next level of the tree; determining if the number of child nodes of the selected node exceeds a predetermined level maximum number of child nodes; and, if the number of child nodes of the selected node exceeds the predetermined level maximum number of child nodes, displaying a single subset of the child nodes and at least one selectable affordance for displaying another subset of the child nodes.

A second aspect of the present invention provides a system for displaying and navigating a tree, comprising: a system for selecting a node on a level of the tree, wherein the node has a number of child nodes on a next level of the tree; a system for determining if the number of child nodes of the selected node exceeds a predetermined level maximum number of child nodes; and a system for displaying a single subset of the child nodes and at least one selectable affordance for displaying another subset of the child nodes, if the number of child nodes of the selected node exceeds the predetermined level maximum number of child nodes.

A third aspect of the present invention provides a program product stored on a recordable medium for displaying and navigating a tree, which when executed comprises: program code for selecting a node on a level of the tree, wherein the node has a number of child nodes on a next level of the tree; program code for determining if the number of child nodes of the selected node exceeds a predetermined level maximum number of child nodes; and program code for displaying a single subset of the child nodes and at least one selectable affordance for displaying another subset of the child nodes, if the number of child nodes of the selected node exceeds the predetermined level maximum number of child nodes.

A fourth aspect of the present invention provides a system for deploying an application for displaying and navigating a tree, comprising: a computer infrastructure being operable to: detect a selection of a node on a level of the tree, wherein the node has a number of child nodes on a next level of the tree; determine if the number of child nodes of the selected node exceeds a predetermined level maximum number of child nodes; and display a single subset of the child nodes and at least one selectable affordance for displaying another subset of the child nodes, if the number of child nodes of the selected node exceeds the predetermined level maximum number of child nodes.

A fifth aspect of the present invention provides computer software embodied in a propagated signal for displaying and navigating a tree, the computer software comprising instructions to cause a computer system to perform the following functions: detect a selection of a node on a level of the tree, wherein the node has a number of child nodes on a next level of the tree; determine if the number of child nodes of the selected node exceeds a predetermined level maximum number of child nodes; and display a single subset of the child nodes and at least one selectable affordance for displaying another subset of the child nodes, if the number of child nodes of the selected node exceeds the predetermined level maximum number of child nodes.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a tree having eight nodes in a first level.

FIG. 2 depicts the tree of FIG. 1, where a node in the first level has been expanded and includes twenty-six child nodes in a second level of the tree.

FIG. 3 depicts a flow diagram illustrating the process flow of a method in accordance with an embodiment of the present invention.

FIGS. 4-7 illustrate an example of an embodiment of the present invention.

FIG. 8 illustrates an example of another embodiment of the present invention.

FIG. 9 illustrates an example of another embodiment of the present invention.

FIG. 10 depicts an example of another embodiment of the present invention.

FIG. 11 depicts a computer system for implementing the method of the present invention.

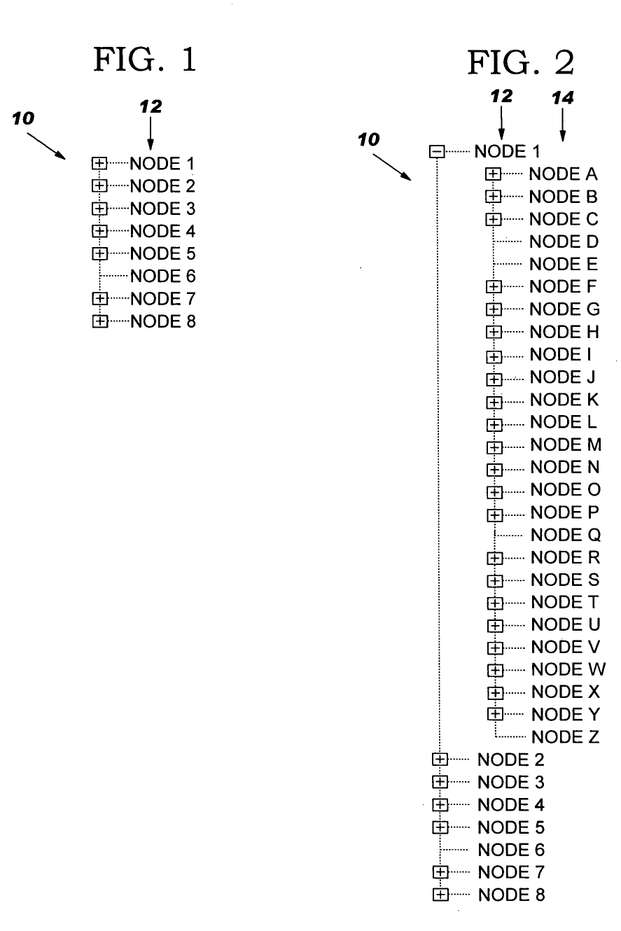

The drawings are merely schematic representations, not intended to portray specific parameters of the invention, and are not necessarily to scale. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a method, system, and computer program product for navigating and displaying very large trees representing hierarchically-structured data.

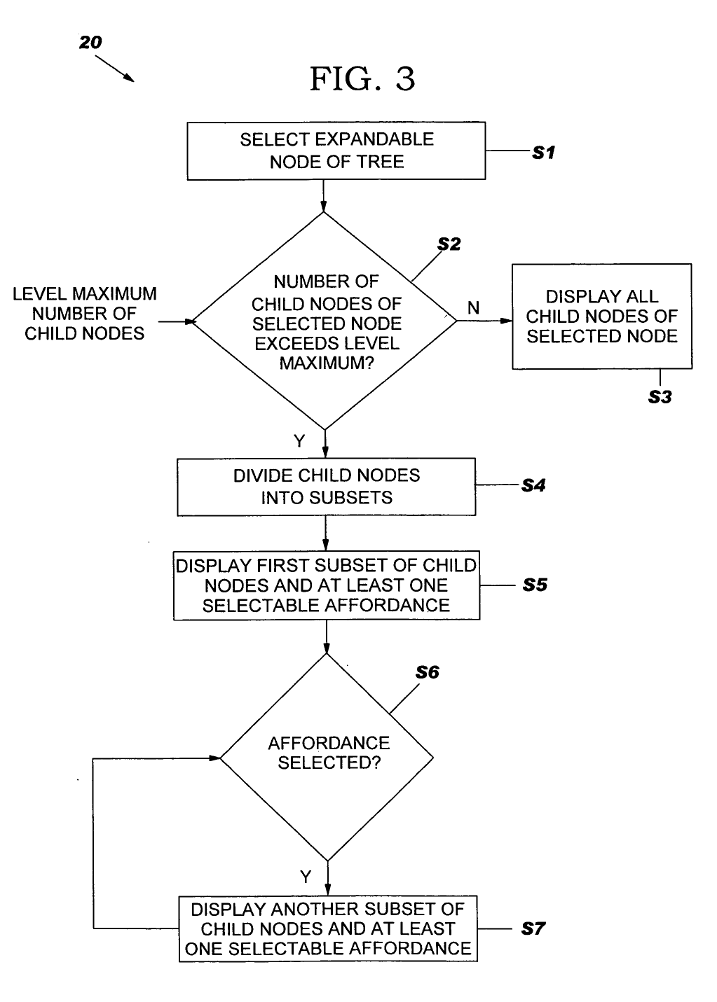

A flow diagram 20 illustrating the process flow of a method in accordance with the present invention is provided in FIG. 3. In step S1, an expandable node in a tree is selected in a conventional manner by a user (e.g., using a mouse, touchpad, keyboard, etc.). In step S2, the number of child nodes of the selected node is compared to a predetermined level maximum number of child nodes. The level maximum number of child nodes can be set by a user, or can be determined automatically (e.g., by an application) based on such factors as window size, processing capabilities, transmission bandwidth, etc. Many other factors are also possible. The level maximum number of child nodes can be provided by a user before the display of a tree. A user can also change the level maximum number of child nodes “on-the-fly” during the display of a tree to change the number of child nodes in the displayed subset of child nodes. Other methods for providing the level maximum number of child nodes are also possible.

If the number of child nodes of the selected node does not exceed the level maximum number of child nodes, then in step S3, all of the child nodes of the selected node are displayed in a conventional manner. If, however, the number of child nodes of the selected node exceeds the level maximum number of child nodes, then in step S4, the child nodes of the selected node are divided into a plurality of subsets. The division can be accomplished by dividing the number of child nodes of the selected node by the level maximum number of child nodes. If the division results in an integer number of subsets, then each subset of child nodes contains the level maximum number of child nodes. If the division does not result in an integer number of subsets, then all but one of the subsets of child nodes contain the level maximum number of child nodes. Any remaining child nodes are provided in another subset of child nodes (e.g., in the last subset).

In step S5, the first subset of the child nodes of the selected node are displayed together with at least one selectable affordance. The affordance can comprise, for example, “Next Subset,” “Last Subset,” “First Subset,” “Previous Subset,” etc. If an affordance is selected in step S6, then in step S7, the display is refreshed, displaying another subset of child nodes and at least one affordance. For example, selection of the affordance “Next Subset” causes the display to refresh, displaying the next subset of child nodes, where the next subset of child nodes also contains the level maximum number of child nodes. At this point, the first subset of child nodes is no longer displayed. Selection of the affordance “Last Subset” causes the display to refresh, displaying the last subset of child nodes, where the last subset of child nodes contains, at most, the level maximum number of child nodes. Once past the initial subset of child nodes, the affordance “First Subset” can be selected to again display the first subset of child nodes. Likewise, the affordance “Previous Subset” can be selected to display the previously displayed subset of child nodes. Other affordances are also possible. It should be noted that at any given time, only a single subset of the child nodes of the selected node is displayed.

Steps S6 and S7 can be repeated as necessary to display and navigate through some or all of the subsets of the child nodes of the selected node. The user may also choose, at any time, to select any expandable node that is displayed to navigate to that node in the tree. The process of the present invention can then be repeated for the selected expandable node. To this extent, the process of the present invention can be applied to all expandable nodes throughout the tree, at any level, and can be used even when nodes are expanded concurrently.

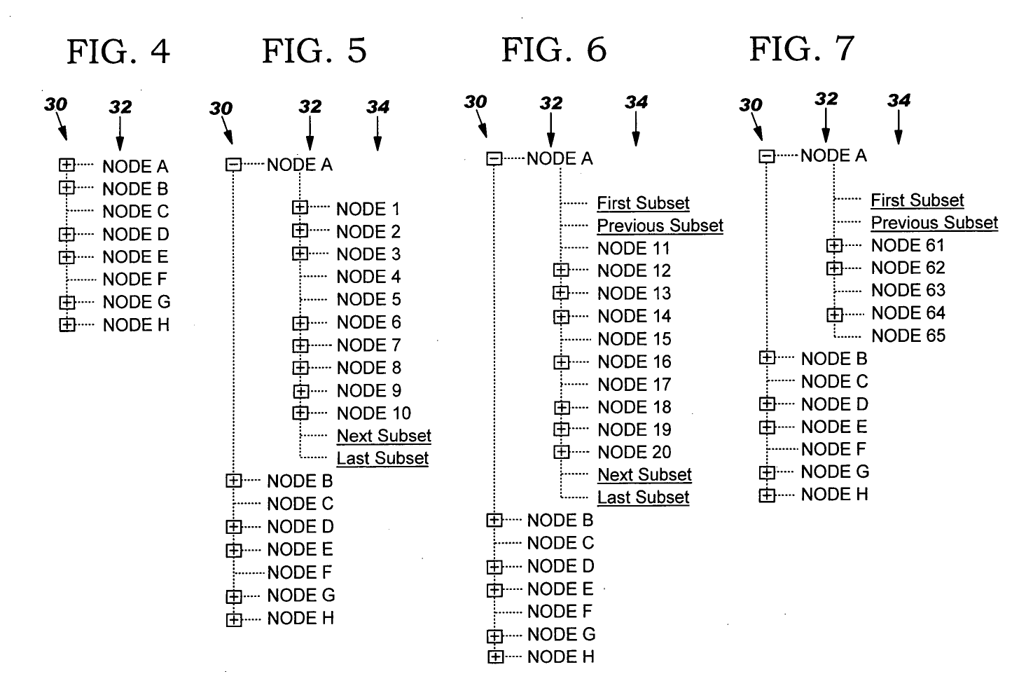

An example illustrating an embodiment of the present invention is shown in FIGS. 4-7. FIG. 4 illustrates a tree 30 having eight nodes (NODE A, NODE B, . . . NODE H) at a first level 32. In this example, it is assumed that NODE A has sixty-five child nodes at the next level 34 of the tree 30. Upon selection of NODE A, assuming that the level maximum number of child nodes is set (e.g., by a user) to ten, the tree 30 now appears as shown in FIG. 5. As shown, only the first subset of ten child nodes (NODE 1, NODE 2, . . . , NODE 10) is displayed in the next level 34 of the tree 30, along with a pair of selectable affordances, “Next Subset” and “Last Subset” located after the displayed subset of child nodes. The remaining fifty-five child nodes (NODE 11, NODE 12, . . . , NODE 65) of NODE A are not displayed. Subsequent selection of the affordance “Next Subset” will result in the display of the next ten child nodes of NODE A (NODE 11, NODE 12, . . . , NODE 20), while selection of the affordance “Last Subset” will result in the display of the last five child nodes of NODE A (NODE 61, NODE 62, . . . , NODE 65).

Upon selection of the affordance “Next Subset,” the tree 30 now appears as shown in FIG. 6. As shown, the second subset of ten child nodes (NODE 11, NODE 12, . . . , NODE 20) is now displayed in the next level 34 of the tree 30. Also displayed are the pair of selectable affordances, “Next Subset” and “Last Subset” located after the displayed subset of child nodes, and another pair of selectable affordances, “First Subset” and “Previous Subset,” located before the displayed subset of child nodes. As before, subsequent selection of the affordance “Next Subset” will result in the display of the next ten child nodes of NODE A (NODE 21, NODE 22, . . . , NODE 30), while selection of the affordance “Last Subset” will result in the display of the last five child nodes of NODE A (NODE 61, NODE 62, . . . , NODE 65). In addition, subsequent selection of the affordance “First Subset” will result in the display of the first ten child nodes of NODE A (NODE 1, NODE 2, . . . , NODE 10), while selection of the affordance “Previous Subset” will result in the display of the previously displayed subset of child nodes, which in this case also results in the display of the first ten child nodes of NODE A (NODE 1, NODE 2, . . . , NODE 10). In this case, the affordance “Previous Subset” is redundant and does not have to be displayed, if desired.

Upon selection of the affordance “Last Subset,” the tree 30 now appears as depicted in FIG. 7. As shown, only the last subset of five child nodes (NODE 61, NODE 62, . . . , NODE 65) is now displayed in the next level 34 of the tree 30. Also displayed are the pair of selectable affordances, “First Subset” and “Previous Subset,” located before the displayed subset of child nodes. Since the last subset of child nodes of NODE A is displayed, the affordances “Next Subset” and “Last Subset” are not required.

From FIGS. 4-7, it will be apparent to those skilled in the art that use of the present invention greatly simplifies the display and navigation of large trees. Further, because only a single subset of child nodes is displayed at any time, the processing and display requirements are significantly reduced as compared to the prior art.

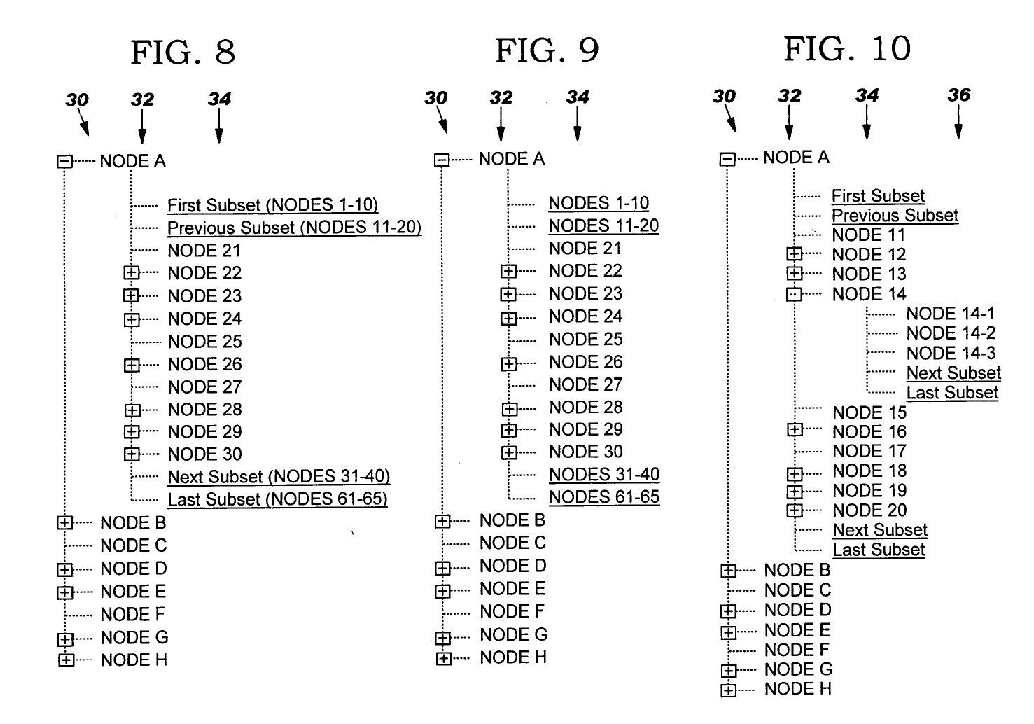

Another embodiment of the present invention is displayed in FIG. 8, in which the third subset of child nodes (NODE 21, NODE 22, . . . , NODE 30) of NODE A of tree 30 (FIG. 4) are displayed. In this embodiment, the affordances are provided with additional information to facilitate navigation. For example, the affordance “First Subset (NODES 1-10)” provides information regarding the specific nodes (NODES 1-10) within the first subset of child nodes. Similar information is also provided in the affordances “Previous Subset (NODES 11-20),” “Next Subset (NODES 31-40),” and “Last Subset (NODES 61-65).” In another embodiment of the present invention, as shown in FIG. 9, the affordances can simply provide a list of the nodes within each subset. Many other variations are also possible.

It should be noted that the level maximum number of child nodes can be the same or different for each level of the tree, and can be set as detailed above by a user or automatically (e.g., by an application). An example of the use of different level maximums is shown in FIG. 10, wherein the level maximum number of child nodes in level 34 of tree 30 is ten, while the level maximum number of child nodes in level 36 of tree 30 is three.

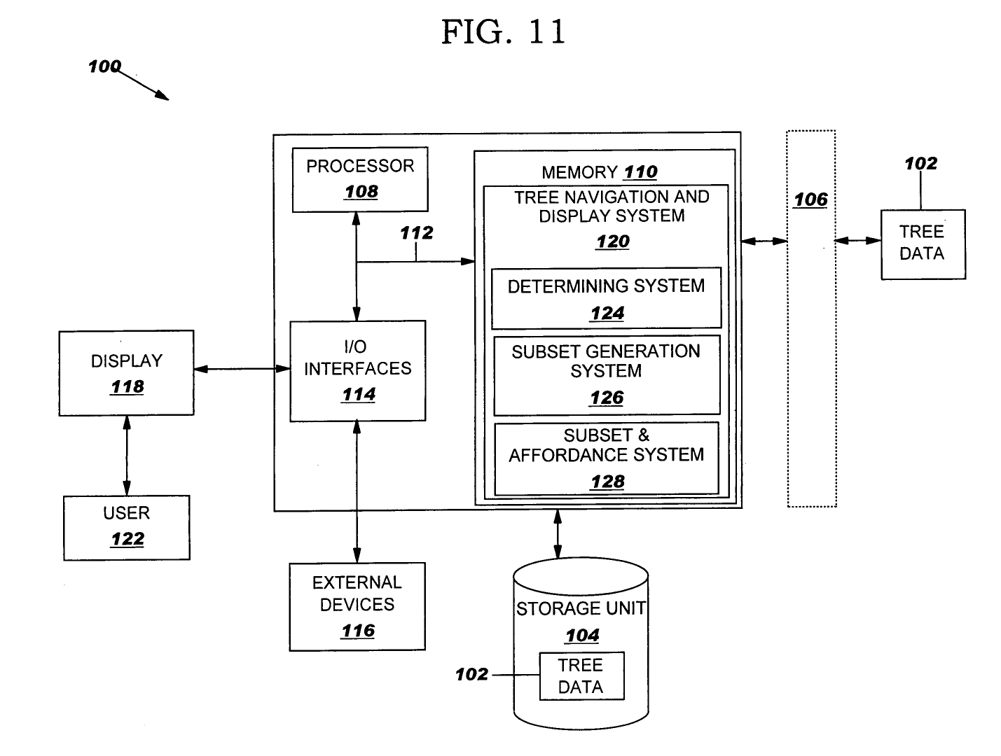

Referring now to FIG. 11, there is illustrated a computer system 100 for navigating and displaying very large trees representing hierarchically-structured data in accordance with the present invention. Computer system 100 is intended to represent any type of computerized system capable of implementing the methods of the present invention. For example, computer system 100 may comprise a desktop computer, laptop computer, workstation, server, hand-held device, pager, etc.

The tree data 102 can be stored locally to computer system 100, for example, in storage unit 104, and/or may be provided to computer system 100 over a network 106. Storage unit 104 can be any system capable of providing storage for data and information under the present invention. As such, storage unit 104 may reside at a single physical location, comprising one or more types of data storage, or may be distributed across a plurality of physical systems in various forms. In another embodiment, storage unit 104 may be distributed across, for example, a local area network (LAN), wide area network (WAN) or a storage area network (SAN) (not shown). Network 106 is intended to represent any type of network over which data can be transmitted. For example, network 106 can include the Internet, a wide area network (WAN), a local area network (LAN), a virtual private network (VPN), a WiFi network, or other type of network. To this extent, communication can occur via a direct hardwired connection or via an addressable connection in a client-server (or server-server) environment that may utilize any combination of wireline and/or wireless transmission methods. In the case of the latter, the server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server.

As shown, computer system 100 generally includes a processor 108, memory 110, bus 112, input/output (I/O) interfaces 114 and external devices/resources 116. Processor 108 may comprise a single processing unit, or may be distributed across one or more processing units in one or more locations, e.g., on a client and server. Memory 110 may comprise any known type of data storage and/or transmission media, including magnetic media, optical media, random access memory (RAM), read-only memory (ROM), etc. Moreover, similar to processor 108, memory 110 may reside at a single physical location, comprising one or more types of data storage, or be distributed across a plurality of physical systems in various forms.

I/O interfaces 114 may comprise any system for exchanging information to/from an external source. External devices/resources 116 may comprise any known type of external device, including speakers, a CRT, LED screen, handheld device, keyboard, mouse, voice recognition system, speech output system, printer, monitor/display (e.g., display 118), facsimile, pager, etc.

Bus 112 provides a communication link between each of the components in computer system 100, and likewise may comprise any known type of transmission link, including electrical, optical, wireless, etc. In addition, although not shown, other components, such as cache memory, communication systems, system software, etc., may be incorporated into computer system 100.

Shown in memory 110 is tree navigation and display system 120, which may be provided as a computer program product. The tree navigation and display system 120 is configured to generate and display a tree to a user 122 on display 118, and to allow user 122 to navigate through the tree, using the methods of the present invention. The tree navigation and display system 120 includes a determining system 124 for determining whether the number of child nodes of a selected node in the tree exceeds a predetermined level maximum number of nodes, a subset generation system 126 for dividing, if necessary, the child nodes of the selected node into a plurality of subsets, and a subset and affordance system 128 for displaying one of the subsets and at least one affordance on the display, and for providing navigation through the subsets of child nodes based on the selection of an affordance. The predetermined level maximum number of child nodes for each level (which may be same or different for each level) may be provided by user 122 and stored in storage unit 104, where it can be accessed by the determining system 124. The predetermined level maximum number of child nodes can also be automatically provided to the determining system 124, based for example, on such factors as window size, processing capabilities, transmission bandwidth, etc.

It should be appreciated that the teachings of the present invention could be offered as a business method on a subscription or fee basis. For example, computer system 100 could be created, maintained, supported, and/or deployed by a service provider that offers the functions described herein for customers. It should also be understood that the present invention can be realized in hardware, software, a propagated signal, or any combination thereof. Any kind of computer/server system(s)- or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagate signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

We claim:

1. A method for displaying and navigating a tree, comprising:
selecting a node on a level of the tree, wherein the node has a number of child nodes on a next level of the tree;
determining if the number of child nodes of the selected node exceeds a predetermined level maximum number of child nodes; and
if the number of child nodes of the selected node exceeds the predetermined level maximum number of child nodes, displaying a single subset of the child nodes and at least one selectable affordance for displaying another subset of the child nodes.

2. The method of claim 1, wherein each subset of child nodes contains the level maximum number of child nodes.

3. The method of claim 1, where all but one of the subsets of child nodes contains the level maximum number of child nodes.

4. The method of claim 1, further comprising:
dividing the number of child nodes by the level maximum number of child nodes into a plurality of subsets.

5. The method of claim 1, wherein the level maximum number of child nodes is user selectable.

6. The method of claim 1, wherein the level maximum number of child nodes is determined automatically.

7. The method of claim 1, wherein the level maximum number of child nodes can be different for each level of the tree.

8. The method of claim 1, wherein selection of the affordance displays a subset of the child nodes selected from the group consisting of a next subset of the child nodes, a last subset of the child nodes, a first subset of the child nodes, and a previous subset of the child nodes.

9. The method of claim 1, wherein each affordance displays information identifying the specific child nodes within the other subset.

10. A system for displaying and navigating a tree, comprising:
a system for selecting a node on a level of the tree, wherein the node has a number of child nodes on a next level of the tree;
a system for determining if the number of child nodes of the selected node exceeds a predetermined level maximum number of child nodes; and
a system for displaying a single subset of the child nodes and at least one selectable affordance for displaying another subset of the child nodes, if the number of child nodes of the selected node exceeds the predetermined level maximum number of child nodes.

11. The system of claim 10, wherein each subset of child nodes contains the level maximum number of child nodes.

12. The system of claim 10, where all but one of the subsets of child nodes contains the level maximum number of child nodes.

13. The system of claim 10, further comprising:
a system for dividing the number of child nodes by the level maximum number of child nodes into a plurality of subsets.

14. The system of claim 10, wherein the level maximum number of child nodes is user selectable.

15. The system of claim 10, wherein the level maximum number of child nodes is determined automatically.

16. The system of claim 10, wherein the level maximum number of child nodes can be different for each level of the tree.

17. The system of claim 10, wherein, upon selection of the affordance, the system for displaying displays a subset of the child nodes selected from the group consisting of a next subset of the child nodes, a last subset of the child nodes, a first subset of the child nodes, and a previous subset of the child nodes.

18. The system of claim 10, wherein each affordance displays information identifying the specific child nodes within the other subset.

19. A program product stored on a recordable medium for displaying and navigating a tree, which when executed comprises:
program code for selecting a node on a level of the tree, wherein the node has a number of child nodes on a next level of the tree;
program code for determining if the number of child nodes of the selected node exceeds a predetermined level maximum number of child nodes; and
program code for displaying a single subset of the child nodes and at least one selectable affordance for displaying another subset of the child nodes, if the number of child nodes of the selected node exceeds the predetermined level maximum number of child nodes.

20. The program product of claim 19, wherein each subset of child nodes contains the level maximum number of child nodes.

21. The program product of claim 19, where all but one of the subsets of child nodes contains the level maximum number of child nodes.

22. The program product of claim 19, further comprising:
program code for dividing the number of child nodes by the level maximum number of child nodes into a plurality of subsets.

23. The program product of claim 19, wherein the level maximum number of child nodes is user selectable.

24. The program product of claim 19, wherein the level maximum number of child nodes is determined automatically.

25. The program product of claim 19, wherein the level maximum number of child nodes can be different for each level of the tree.

26. The program product of claim 19, wherein, upon selection of the affordance, the program product for displaying displays a subset of the child nodes selected from the group consisting of a next subset of the child nodes, a last subset of the child nodes, a first subset of the child nodes, and a previous subset of the child nodes.

27. The program product of claim 19, wherein each affordance displays information identifying the specific child nodes within the other subset.

28. A system for deploying an application for displaying and navigating a tree, comprising:
a computer infrastructure being operable to:
detect a selection of a node on a level of the tree, wherein the node has a number of child nodes on a next level of the tree;
determine if the number of child nodes of the selected node exceeds a predetermined level maximum number of child nodes; and
display a single subset of the child nodes and at least one selectable affordance for displaying another subset of the child nodes, if the number of child nodes of the selected node exceeds the predetermined level maximum number of child nodes.

29. Computer software embodied in a propagated signal for displaying and navigating a tree, the computer software comprising instructions to cause a computer system to perform the following functions:
detect a selection of a node on a level of the tree, wherein the node has a number of child nodes on a next level of the tree;
determine if the number of child nodes of the selected node exceeds a predetermined level maximum number of child nodes; and
display a single subset of the child nodes and at least one selectable affordance for displaying another subset of the child nodes, if the number of child nodes of the selected node exceeds the predetermined level maximum number of child nodes.
